(19) United States
(12) Patent Application Publication
(10) Pub. No.: US 2013/0220055 A1
(43) Pub. Date: Aug. 29, 2013

(54) MULTIFUNCTIONAL INTEGRATED SHIFTER

(71) Applicant: JOHN CURL, Franklin, TN (US)

(72) Inventor: JOHN CURL, Franklin, TN (US)

(73) Assignee: NISSAN NORTH AMERICA, INC., Franklin, TN (US)

(21) Appl. No.: 13/406,693

(22) Filed: Feb. 28, 2012

(51) Int. Cl. F16H 59/04

(52) U.S. Cl. 74/473.33

(57) ABSTRACT

An integrated multifunctional motor vehicle shifter is disclosed which comprises a selector connected to a surface in the interior of a motor vehicle. The selector is configured to rotate about an axis to select from a first group of driving characteristics, and the selector is also configured to move in at least one direction substantially perpendicular to the axis to select from a second group of driving characteristics. In one embodiment the selector can chose between both driving modes and transmission settings.

### BACKGROUND

Motor vehicles typically have several systems which can be controlled by the driver or passenger contained in the vehicle. As the controls in motor vehicles have become more and more complex, the importance of packaging the controls in accessible locations, while being simple enough for wide ranges of users has become apparent.

### SUMMARY

Disclosed herein are embodiments for multifunctional integrated shifters, which can be used in motor vehicle applications. In one embodiment the multifunctional integrated shifter in a motor vehicle comprises a selector fixed proximate to a surface in the interior of a motor vehicle. The selector is configured to rotate about an axis to select from a set of first driving characteristics. The selector is further configured to move in at least one direction substantially perpendicular to the axis to select from a set of second driving characteristics.

Another embodiment of the multifunctional integrated shifter in a motor vehicle comprises a selector fixed proximate to a surface in the interior of a motor vehicle, wherein the selector is configured to rotate about an axis to allow selection from a first set of driving characteristics. The selector is further configured to move in at least one direction substantially perpendicular to the axis to allow selection from a second set of driving characteristics. The selector also includes a push button switch to select from a third set of driving characteristics.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1A is a perspective drawing of a multifunctional integrated shifter capable of selecting from two driving characteristics;

FIG. 1B is a perspective drawing of a multifunctional integrated shifter capable of selecting from two driving characteristics;

FIG. 2 is a perspective view of a multifunctional integrated shifter capable of selecting from three driving characteristics;

FIG. 3 is a perspective view of a motor vehicle interior with a multifunctional integrated shifter;

FIG. 4 is a perspective view of a multifunctional integrated shifter that can select driving modes, transmission settings, and operation state;

FIG. 5 is a top view of a multifunctional integrated shifter showing a defined path for shifter movement; and

FIG. 6 is a top view of a multifunctional integrated shifter showing a defined path for shifter movement.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

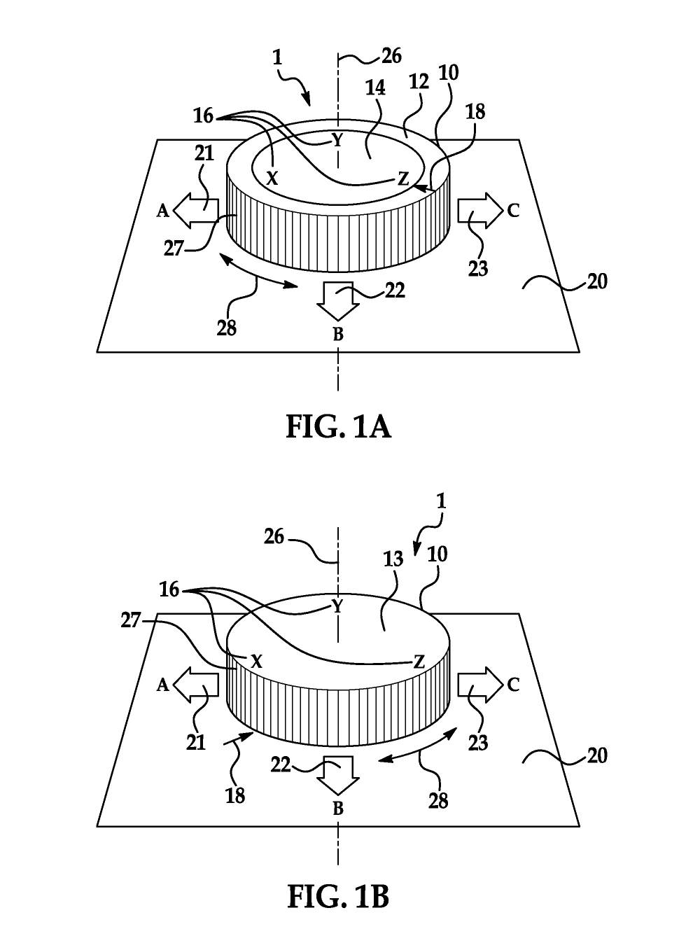

With reference to FIG. 1A, a multifunctional integrated shifter 1 is configured to select driving characteristics from two groups of driving characteristics through a selector 10 which can both rotate about an axis 26 and move in one or more directions substantially perpendicular to the axis 26. The selector 10 can be attached in proximity to a surface 20. The selector 10 can be rotated about the axis 26 in the direction depicted by arrow 28. The selector 10 can consist of an outer member 12 and an inner member 14. The outer member 12 of selector 10 can be configured to rotate about axis 26 in the direction 28, while the inner member 14 remains fixed and non-rotatable.

In the example embodied in FIG. 1A, in which the outer member 12 rotates around the inner member 14, a first driving characteristic can be selected from a first group of driving characteristics by the selector 10. The first group of driving characteristics can be denoted with first characteristic labels 16 on the inner member 14, and a first driving characteristic indicator 18 can be located on the outer member 12 to illustrate which of the first driving characteristics is chosen. Alternatively, in another non-limiting example, the first characteristic labels 16 can be on the outer member 12, with the first characteristic indicator 18 on the inner member 14. As another alternative, one of the first characteristic indicator 18 and the first characteristic labels 16 can be on surface 20 with the other located on the outer member 12. Indication of which of the first driving characteristics is selected can be accomplished through a separate indicator located in the interior of the motor vehicle, such as on the surface 20, dashboard or instrument panel of the vehicle. The indication of the selected first driving characteristic can be an illuminated indication. The number of driving characteristics in the first group of driving characteristics is illustrated as three, but can be more or less as desired or required by those skilled in the art.

Referring now to FIG. 1B, the selector 10 can consist of a one shifter member 13 that is rotatable around axis 26. As with the embodiment shown in FIG. 1A, one of the first characteristic indicator 18 and the first characteristic labels 16 can be on surface 20 with the other located on the one shifter member 13. Indication of which of the first driving characteristics is selected can be accomplished through a separate indicator located in the interior of the motor vehicle, such as on the surface 20, dashboard or instrument panel of the vehicle. The indication of the selected first driving characteristic can be an illuminated indication. The number of driving characteristics in the first group of driving characteristics is illustrated as three, but can be more or less as desired or required by those skilled in the art.

As shown in FIG. 1A, a second driving characteristic is selectable from a second group of driving characteristics by moving both the inner member 14 and outer member 14 of the selector 10 together in a direction substantially perpendicular to the axis 26. As shown in FIG. 1B, a second driving characteristic is selectable from a second group of driving characteristics by moving the one shifter member 13 in a direction substantially perpendicular to the axis 26.

Directions 21, 22, 23 are non-limiting examples of different directions that are substantially perpendicular to the axis 26. The number of directions 22 can coincide with the number of second driving characteristics in the second group of driving characteristics from which the driver can select. Moving the selector 10 in one of directions 22 can select the second driving characteristic from the second group of driving characteristics. Second characteristic indicators A, B, C are illustrated on the surface 20. However, the second characteristic indicators A, B, C can be located elsewhere, such as on the outer member 12. Indication of which of the second group of driving characteristics is selected can be accomplished through a separate indicator located in the interior of the motor vehicle, such as on the surface 20, dashboard or instrument panel of the vehicle. The indication of the selected second driving characteristic can be an illuminated indication. The number of driving characteristics in the second group of driving characteristics is illustrated as three, but can be more or less as desired or required by those skilled in the art.

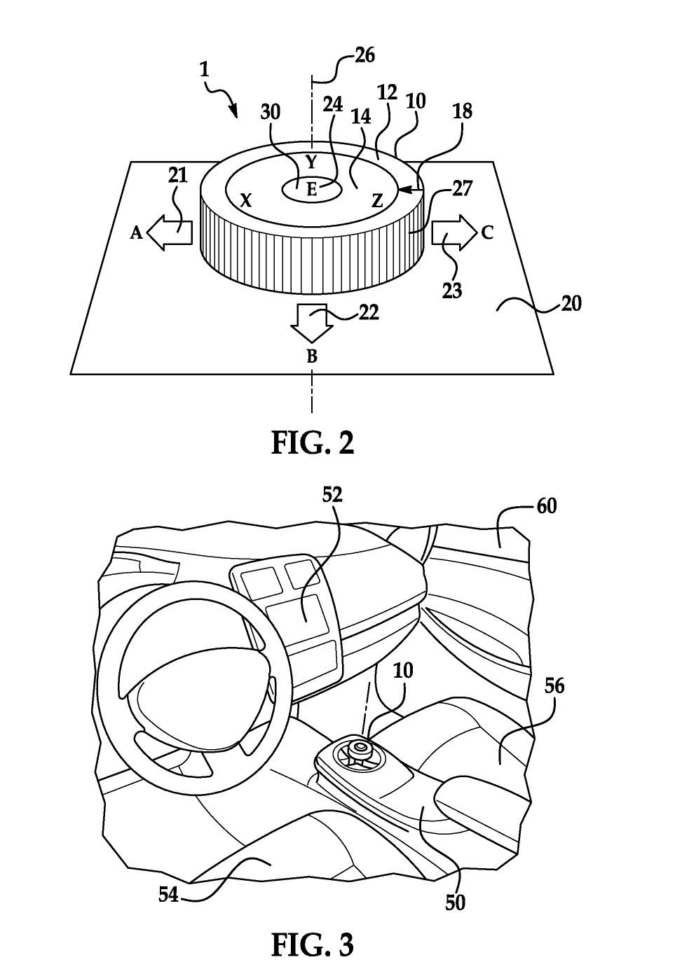

In another embodiment shown in FIG. 2, a push button 30 can be incorporated on the selector 10 configured to select a third driving characteristic from a third group of driving characteristics. The push button 30 can act as a switch when depressed. The push button 30 can be located anywhere on the selector 10, and in one example is located centered in the inner member 14 of selector 10, such that the axis 26 runs through the center of the push button 30. The push button 30 can also be located within the one shift member 13 of FIG. 1B.

As a non-limiting example, a third characteristic label 24 can be located on the push button 30. Indication of which of the third driving characteristics is selected can be accomplished through a separate indicator located in the interior of the motor vehicle, such as on the surface 20, dashboard or instrument panel of the vehicle. The indication of the selected first driving characteristic can be an illuminated indication. The number of driving characteristics in the third group of driving characteristics is two-one denoted by the neutral state of the push button 30 and one denoted by the pushed state of the push button 30. The push button 30 can be flush with a surface of the surrounding inner member 14 or one shifter member 13, or can be slightly raised or below the surface.

Referring now to FIG. 3, the selector 10 can be located in a variety of positions in an interior 60 of a motor vehicle. One embodiment in FIG. 3 has the selector 10 located on a center console 50, which sits between a driver seat 54 and passenger seat 56. As another non-limiting example, the selector 10 can be located on an instrument panel 52 or anywhere else in the interior 60 that is easily accessible to the driver during driving.

The selector 10 can consist of any material known to those skilled in the art of motor vehicle interiors, including but not limited to plastics and metal. Furthermore, the selector 10 does not have to be round in shape, but can be a variety of shapes and sizes. For example, the selector 10 can be any polygonal prism that has a center axis around which it rotates. Furthermore, the selector 10 can have an outer surface 27 that is smooth, or textured to allow a driver to more easily grip the selector 10. The outer surface 27 can be the same material as the selector 10, or any other material suitable for the interior of motor vehicles.

The surface 20 can be fixedly attached to the selector 10 such that it moves with the selector 10, and the surface 20 can be integrated in the vehicle separately from the selector 10 such that selector 10 moves relative to surface 20. The surface 20 can be made of any material suitable for the interior of a motor vehicle, and can be substantially flat, or any other shape which would not interfere with the selector 10 moving in a direction substantially perpendicular to the axis 26. Surface 20 can be rigid, or flexible and capable of deforming.

Several different groups of driving characteristics may be implemented with the selector 10. A non-exhaustive list of possible groups of driving characteristics can from which the first, second and third groups of driving characteristics can comprise include: driving modes, transmission settings, operational states of a vehicle system, interior climate controls, cruise control, radio controls, navigation settings, phone setting, etc. Furthermore, each driving characteristic can consist of a plurality of selectable settings, and the embodiments disclosed herein are only examples of the number of selectable settings possible for each driving characteristic. The first group of driving characteristic can be associated with one of rotating the selector 10 about the axis 26, moving the selector 10 substantially perpendicular to the axis 26, and pushing a push button 30 on the selector 10. The second and third groups of driving characteristics can each be associated with one of the remainder of rotating the selector 10 about the axis 26, moving the selector 10 substantially perpendicular to the axis 26, and pushing a push button 30 on the selector 10.

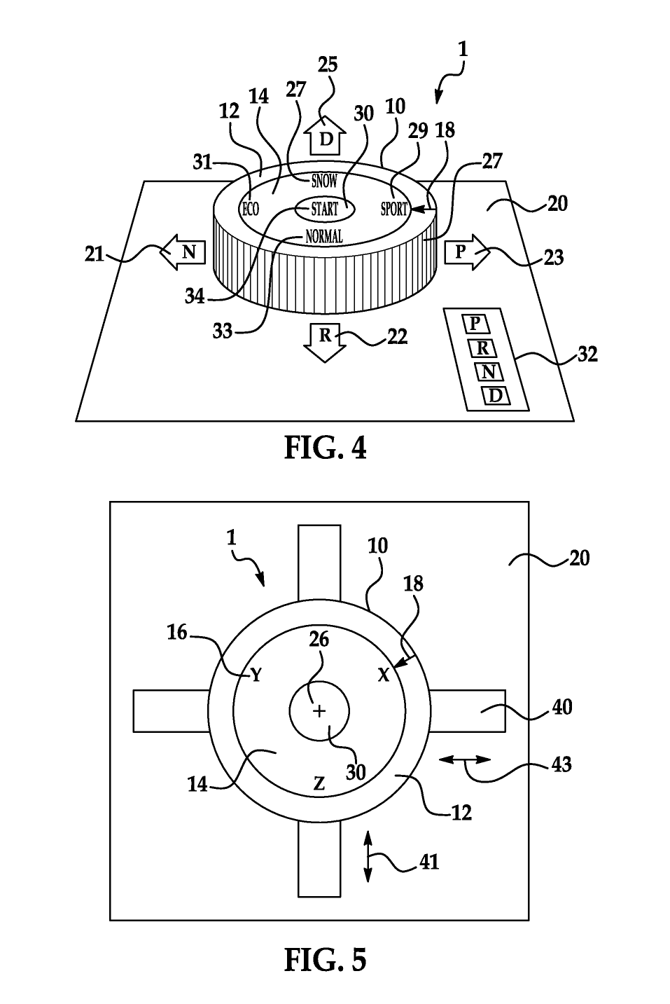

One of the groups of driving characteristics that can be selected using the selector 10 is driving modes. The driving modes can include any settings that alter a vehicles engine, transmission, or suspension performance. For example, there can be a plurality of driving modes based on exterior and roadway conditions or vehicle performance levels as shown in FIG. 4, where the driving mode is selected by rotating the outer member 12. A snow driving mode 27 may be selectable that changes the vehicles traction control and/or raises the suspension of the vehicle. There can be a sport driving mode 29 that may alter shift points and/or stiffen up the vehicles suspension. There can be an eco-driving mode 31 which optimizes engine and transmission performance to use less fuel or battery power. There can be a normal driving mode 33 which balances vehicle systems to optimize power and economy. Several other driving modes may be selectable as the above are only examples, including driving modes which change the vehicle from four-wheel-drive to two-wheel-drive, and vice-versa. Alternatively, the group of driving modes can be selected by moving the selector 10 substantially perpendicular to the axis 26 around which the selector 10 can rotate.

Another group of driving characteristics that can be associated with the selector 10 can be transmission settings. In one example, the group of driving characteristics is a plurality of transmission settings, where the transmission settings are automatic transmission modes as depicted in FIG. 4. Moving the selector 10 in a neutral direction 21 (N) can shift the transmission into neutral. Similarly, moving the selector 10 in a reverse direction 22 (R), parking direction 23 (P), or drive direction 25 (D) can select the respective transmission settings for an automatic transmission. Alternatively, the transmission settings can be selectable by rotating selector 10 along the axis 26. In yet another example, the selector 10 can select from a plurality of transmission settings where the transmission settings are manual transmission modes or gear ratios. There can be a transmission setting indicator 32 integrated with the selector 10 to allow the user to view what transmission setting has been selected by selector 10. The transmission setting indicator 32 can be located on the selector 10, on the surface 20 near the selector 10, on the instrument panel of the vehicle, or in other places in the interior of the vehicle viewable by the driver. More than one indication for the same group of driving characteristics can be incorporated into the vehicle.

For selecting transmission settings, the selector 10 can be configured to send electrical signals for purposes of changing the transmission settings for use in a vehicle with a shift-by-wire transmission system. In a shift-by-wire system, the shifting of the automobile is done electronically, without a shift cable. Furthermore, if the vehicle does incorporate a traditional shift cable, the selector 10 can be capable of sending an input to the shift cable to select a transmission setting. Also, if the selector 10 selects from a plurality of transmission settings as described in any of the above embodiments, the selector 10 can comply with all motor vehicle safety provisions, such as incorporating a brake transmission shift interlock (BITSI), park detect switch, reverse cameras, automatic door locking, etc.

One of the groups of driving characteristics that the selector 10 can be configured to select can be an operational state of a vehicle power system. In FIG. 4, the push button 30 can signal the engine of the motor vehicle to turn on/off, and can be labeled with an operational state label 34 (“start”, for example). In one example, the push button 30 can signal an electric car to turn on or off the electric motor which drives the car. In another non-limiting example, the push button 30 can send a signal which will turn on a gas engine. Furthermore, other embodiments can exist where the operational state is selectable by rotating selector 10. Similarly, the operational state can be selected by movement substantially perpendicular to the axis 26 of rotation.

The substantially perpendicular directions along which the selector 10 can be configured to move may be pre-determined, such as discrete paths in the surface 20. FIG. 5 illustrates an embodiment in which the selector 10 can move along a discrete path 40. Selector 10 can move along the path 40 in the direction of arrows 41 and 43. The selector 10 can be configured to lock into positions along the path 40 to select from the second group of driving characteristics. In other embodiments, the selector 10 can be configured to move along the discrete path 40 to select from the second group of driving characteristics, and then return back to a starting or neutral position.

Furthermore, selector 10 can move in a direction straight away from the axis 26, or can move away from the axis 26 while changing orientation. For example, the selector 10 may move on curved or slanted paths away from a center position and axis 26.

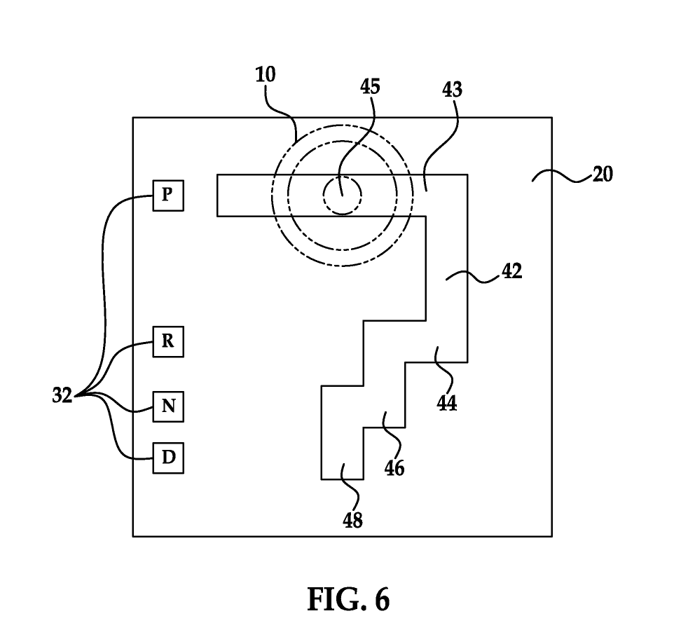

Referring now to FIG. 6, selector 10 can be configured to move along a non-symmetrical path 42. The second group of driving characteristics can be transmission settings as shown in FIG. 6 (P, R, N, D), and the location of the selector 10 along the non-symmetrical path 42 can correspond to selection of the different transmission settings. For example, the selector 10 may select the transmission setting “park” when located in a park area 43 of the non-symmetrical path 42. Moving the selector 10 to a reverse area 44 can select “reverse”, moving to a neutral area 46 can place the car in “neutral”, and moving the selector 10 to a drive area 48 can select the “drive” transmission setting. The transmission setting indicator 32 can be near the selector 10 as shown in FIG. 6, and there can be a separate indication of which transmission setting was selected, such as a light on the instrument panel. A connector 45 can be used to confine the selector 10 of shifter 1 to the pre-determined track 42. Similar configurations can apply to a different group of driving characteristic as well.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A multifunctional integrated shifter in a motor vehicle comprising:
a selector connected to a surface in an interior of the motor vehicle, the selector configured to rotate about an axis to select from a first group of driving characteristics and configured to move in at least one direction substantially perpendicular to the axis to select from a second group of driving characteristics.

2. The multifunctional integrated shifter of claim 1, wherein the selector further comprises a push button switch located on the selector to select from a third group of driving characteristics.

3. The multifunctional integrated shifter of claim 2, wherein the third group of driving characteristics comprises an operational state of a power system of the motor vehicle.

4. The multifunctional integrated shifter of claim 2, wherein the push button switch is located on the axis centered in the selector.

5. The multifunctional integrated shifter of claim 1, wherein the first group of driving characteristics comprises vehicle drive modes.

6. The multifunctional integrated shifter of claim 1, wherein the second group of driving characteristics comprises transmission settings.

7. The multifunctional integrated selector of claim 6, wherein the transmission settings are automatic transmission modes.

8. The multifunctional integrated selector of claim 6, wherein the transmission settings are a plurality of gears for a manual transmission.

9. The multifunctional integrated shifter of claim 1, wherein the at least one direction substantially perpendicular to the axis comprises discrete paths along the surface in the interior of the motor vehicle.

10. The multifunctional integrated shifter of claim 9, wherein the discrete paths correspond to different settings of the second group of driving characteristics.

11. The multifunctional integrated selector of claim 1, wherein the surface is located on a center console of the motor vehicle.

12. The multifunctional integrated selector of claim 1, wherein the surface is located on the instrument panel of the motor vehicle.

13. A multifunctional integrated shifter in a motor vehicle comprising:
a selector connected to a surface in an interior of the motor vehicle, wherein the selector is configured to rotate about an axis to allow selection from a first group of driving characteristics and configured to move in at least one direction substantially perpendicular to the axis to allow selection from a second group of driving characteristics, and wherein the selector includes a push button switch to select from a third group of driving characteristics.

14. The multifunctional integrated shifter of claim 13, wherein the first group of driving characteristics comprises vehicle drive modes.

15. The multifunctional integrated shifter of claim 13, wherein the second group of driving characteristics comprises transmission settings.

16. The multifunctional integrated shifter of claim 13, wherein the third group of driving characteristics comprises operational states of a power system of the motor vehicle.

17. The multifunctional integrated shifter of claim 13, wherein:
the at least one direction substantially perpendicular to the axis comprises pre-determined paths along the surface in the interior of the motor vehicle;
the second set of driving characteristics comprises transmission settings; and
the location of the selector along the pre-determined path correspond to the different transmission settings.
